(19) United States
(12) Patent Application Publication
(10) Pub. No.: US 2011/0264519 A1
(43) Pub. Date: Oct. 27, 2011

(54) SOCIAL BEHAVIORAL TARGETING OF ADVERTISEMENTS IN A SOCIAL NETWORKING ENVIRONMENT

(75) Inventors: Kenneth CHAN, San Francisco, CA (US); Darren CHAN, Mountain View, CA (US); Leo CHIU, South San Francisco, CA (US)

(73) Assignee: Webjuice, LLC, Mountain View, CA (US)

(21) Appl. No.: 12/767,554

(22) Filed: Apr. 26, 2010

(51) Int. Cl. G06Q 30/00

(52) U.S. Cl. 705/14.49

(57) ABSTRACT

Processes and systems for tracking and utilizing interactions between users and advertisements within a social network are provided. An exemplary process includes receiving interaction data associated with interactions between users and advertisements and training an adaptive algorithm based on interaction data, user data, and advertisement data. Interaction data may include past interactions with an advertisement by a user, and along with associated user data (e.g., demographic data, social data, etc.), and advertisement data (e.g., advertisement details and targeting criteria), can be used by an adaptive algorithm to identify patterns between user data and advertising data to increase the chances of a desired interaction when placing advertisements to users. The adaptive algorithm may include one or more of an adaptive pattern matching algorithm, regression analysis algorithm, neural network algorithm, or genetic algorithm.

### CROSS REFERENCE TO RELATED APPLICATION

The present application is related to co-pending U.S. patent application Ser. No. ______ (attorney docket no. 68214-20001.00), filed on an even date herewith and titled DIRECT TARGETING OF ADVERTISEMENTS TO SOCIAL CONNECTIONS IN A SOCIAL NETWORK ENVIRONMENT, the entire content of which is incorporated herein by reference.

### BACKGROUND

1. Field

The present invention relates generally to advertising within social networks, and in one particular example, to targeting advertisements to users based on behavioral or historical interactions between users and advertisements within a social networking environment.

2. Related Art

Social networking websites, or social applications that track and enable connections between members (including people, businesses, and other entities), have become prevalent in recent years. Broadly speaking, a social networking website offers users the ability to communicate and interact with other members of the social networking community. For example, users may join the social networking website and may add connections to a number of other users (sometimes referred to as “friends”). The term “connection” or “friend” generally refers to another user for which an association or linking relationship has been formed via the social networking website. Connections may be made manually by users, e.g., via an accepted connection or friend request, or automatically in response to membership in a common social networking group. Users who become connections may be able to view each other's profile or home pages, exchange messages, and so on. For example, a member may post contact information, background information, job information, hobbies, and/or other member-specific data to a location associated with the member on a social networking website. Other members of the social networking website can then review some or all of the posted information.

The various connections of many different users within a social networking website creates a web of connections within the environment. These connections among the users can be exploited by the social networking website or advertisers to offer more relevant information to each user in view of the users' own stated interests in their connections. For example, social networking websites typically incorporate a system for delivering or presenting content to users that is more likely to be relevant to each user than random delivery of content. For example, users may be grouped according to one or more common attributes in their profiles, such as geographic location, demographic information, employer, job type, music preferences, interests, or other attributes. Users of the social networking website or external entities can use these groups to customize or target information delivery so that information that might be of particular interest to a group can be communicated to that group.

### BRIEF SUMMARY

Broadly speaking, and in one particular example, processes and systems for selecting and targeting advertisements to users within a social network are provided. In one example, a process includes receiving interaction data associated with interactions between users and advertisements, and training an adaptive algorithm based on the interaction data, user data, and advertisement data. The interaction data may include past interactions with an advertisement by a user such as selections of the advertisement, e.g., selecting “like” or “dislike,” closing the advertisement window, and so on. The interaction data, along with associated user data (e.g., demographic data, social data) and advertisement data (advertisement details and targeting criteria) can be used to train or tune an adaptive algorithm for scoring or placing advertisements to users. That is, the interaction data can be used to identify patterns between user data and advertising data to increase the chances of a desired interaction when placing advertisements to users. For example, the interaction data can be used to adjust one or more coefficients of an adaptive algorithm. The adaptive algorithm may include one or more of an adaptive pattern matching algorithm, regression analysis algorithm, neural network algorithm, or genetic algorithm.

The process may further include selecting an advertisement for display to a user based on the adaptive algorithm, which may include or operate with a bid-based, variable pricing algorithm. The exemplary process may further identify second users of a first user's social graph (e.g., social connections or groups) that are likely to exhibit similar interactions with advertisements, and may further prioritize second users of the first user's social graph based on common interaction data. The process may further identify potential users to target with an advertisement based on the adaptive algorithm and a received advertisement request.

The process may further include building and using an ontology structure to expand advertisement data for use in the adaptive algorithm. For example, the ontology structure may be built based on user interactions with advertisements, entered keywords, social graphs, and the like, to provide relations between users, user attributes, advertising attributes, keywords, and so on.

According to other embodiments, systems, apparatuses (e.g., computers, server computers, and the like), interfaces, and computer-readable storage media comprising computer-readable instructions for selecting and placing advertisements in a social networking environment are provided.

### BRIEF DESCRIPTION OF THE DRAWINGS

The present application can be best understood by reference to the following description taken in conjunction with the accompanying drawing figures and screen shots included herein, in which like elements may be referred to by like numerals.

FIG. 1 illustrates an exemplary environment for a social networking application and advertising network.

FIG. 2 illustrates an exemplary social advertising network for social targeting of advertisements received from multiple advertising networks, advertisers, publishers, and end users of social network applications.

FIG. 3A illustrates an exemplary advertisement request, including social targeting details.

FIG. 3B illustrates exemplary first and second degree relationships of a first user with second users and social groups.

FIG. 4A illustrates an exemplary process for targeting advertisements within a social networking environment.

FIG. 4B illustrates an exemplary social advertisement generation process, which may be carried out within the process described in FIG. 4A.

FIG. 5 illustrates an exemplary screenshot of a social network webpage having multiple display spots for advertisements.

FIG. 6 illustrates an exemplary advertisement for placement in advertisement spots of a social network webpage.

FIG. 7 illustrates an exemplary social advertisement generation process based on an interaction pattern and adaptive algorithm.

FIG. 8 illustrates an exemplary computer system for carrying out aspects of the processes described herein.

### DETAILED DESCRIPTION OF THE INVENTION

The following description sets forth numerous specific configurations, parameters, and the like. It should be recognized, however, that such description is not intended as a limitation on the scope of the present invention, but is instead provided as a description of exemplary embodiments.

Broadly speaking, and in one example, processes and systems for targeting advertisements in a social network are provided. In one example, a process includes receiving an advertisement request from a first user of a social networking system and an attribute of the first user, where the advertisement request includes an advertisement and at least one social targeting criterion associated with the advertisement. The social targeting criterion may include an indication to target second users of the social networking system having a direct or first degree of connection to the first user, e.g., to target the first user's connections or friends within the social network. In other examples, the targeting criterion may include targeting second users having a second degree (or n-th degree) of connection relative to the first user, e.g., friends of friends of the first user, within a common social networking system or across multiple social networking systems (e.g., across Facebook™, Dogster™, LinkedIn™, etc.).

The process may further cause display of the advertisement to one or more second users according to an advertisement generation process, the advertisement generation process based on the social targeting criterion. The exemplary advertisement generation process may receive a request to place an advertisement for a particular second user, search potential advertisements, and perform a bid-based, variable pricing auction for placement of an advertisement. The bid process can be influenced by the social targeting criterion in a number of ways. In one example, the advertisement generation process filters out potential advertisements that do not meet the social targeting criterion. In other examples, the social targeting criterion is used to weigh or score potential advertisement bids based on their match to the social targeting criterion.

In another example, a process may include receiving interaction data associated with interactions between users and advertisements and training an adaptive algorithm based on the interaction data, user data, and advertisement data. Interaction data may include past interactions with an advertisement by a user, and along with associated user data (e.g., demographic data, social data, etc.), and advertisement data (e.g., advertisement details and targeting criteria), can be used by an adaptive algorithm to identify patterns between user data and advertising data to increase the chances of a desired interaction when placing advertisements to users. The adaptive algorithm may include one or more of an adaptive pattern matching algorithm, regression analysis algorithm, neural network algorithm, or genetic algorithm.

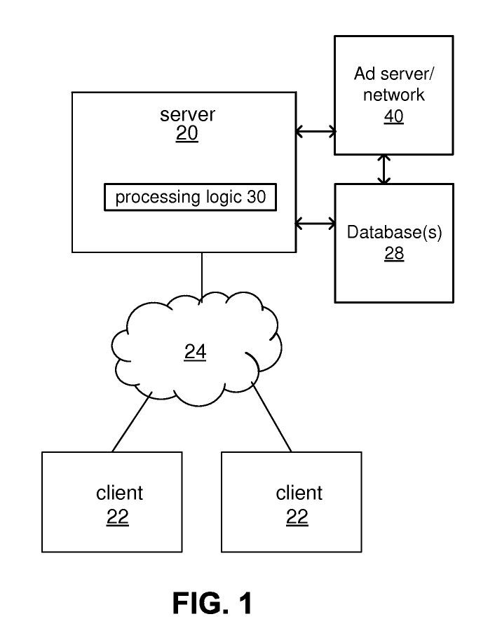

Initially, and with reference to FIG. 1, an exemplary environment in which certain aspects and examples of the user interfaces, apparatuses, and processes described herein may operate is shown. Generally, one or more clients 22 may access a server 20, which includes or accesses logic for performing one or more exemplary processes described, e.g., providing an interface for a user to access a social networking website, submit advertising requests to target users of a social network, and so on. Server 20 and clients 22 may include any one of various types of computer devices, having, e.g., a processing unit, a computer-readable storage memory (which may include logic or software for carrying out some or all of the functions described herein), and a communication interface, as well as other conventional computer components (e.g., input device, such as a keyboard/keypad and/or mouse, output device, such as display). For example, clients 22 may include a desktop computer, laptop computer, mobile device such as a mobile phone, web-enabled phone, smart phone, television, television set-top box, and the like.

Clients 22 and server 20 may communicate, e.g., using suitable communication interfaces via a network 24, such as a Local Area Network (LAN) or the Internet. Clients 22 and server 20 may communicate, in part or in whole, via wireless or hardwired communications, such as Ethernet, IEEE 802.11b wireless, or the like. Additionally, communication between clients 22 and server 20 may include or communicate with various servers such as a mail server, mobile server, media server, and the like.

Server 20 generally includes logic (e.g., http web server logic) or is programmed to format data, accessed from local or remote databases or other sources of data and content, for presentation to users of clients 22, preferably in the format described herein. For example, server 20 may format data and/or access a local or remote database to communicate and cause the display of an interface to clients 22, data related to objects for display within an interface (which may include a search interface and display window for displaying objects, for example), links to additional information and/or content related to the objects, the additional content and/or information itself, and the like.

To this end, server 20 may utilize various web data interface techniques such as Common Gateway Interface (CGI) protocol and associated applications (or “scripts”), Java® “servlets”, i.e., Java® applications running on a web server, or the like to present information and receive input from clients 22. Server 20, although described herein in the singular, may actually comprise plural computers, devices, databases, associated backend devices, and the like, communicating (wired and/or wireless) and cooperating to perform some or all of the functions described herein. Server 20 may further include or communicate with advertising servers/networks 40, account servers (e.g., email servers), mobile servers, photo servers, video servers, and the like.

Further, web pages communicated to clients 22 may include various text and media objects such as articles, documents, photos, audio files, video files, and the like. Additionally, the content may include selections or links to further content accessible by the interface and associated user device, e.g., via Application Programming Interfaces (APIs), web pages, and the like stored or accessed locally or remotely. Content accessible by clients 22 via a presented web page may conform to any suitable data format including various media formats such as still image (e.g., JPEG, TIFF), video (e.g., MPEG, AVI, Flash), or audio (e.g., MP3, OGG).

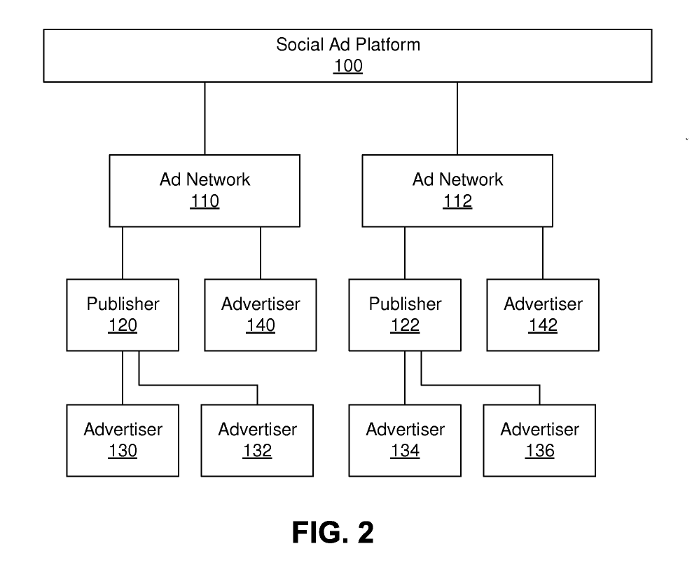

In one example, server 20 may further include or communicate with processing logic 30 for causing the display of an interface for a social networking site as well as placing advertisements for display therewith according to one or more algorithms or processes described. For example, server 20 may include one or more application servers configured to implement and execute software applications as well as provide related data, code, forms, web pages, and other information to and from clients 22 and to store to, and retrieve from, a database system 28 related data, objects and web page content. Further, server 20 may be in communication with advertising server or network 40, which may include one or more advertisers for providing advertisements for display with the social networking applications pages served to clients 22. An exemplary advertiser server/network is described in greater detail with respect to FIG. 2.

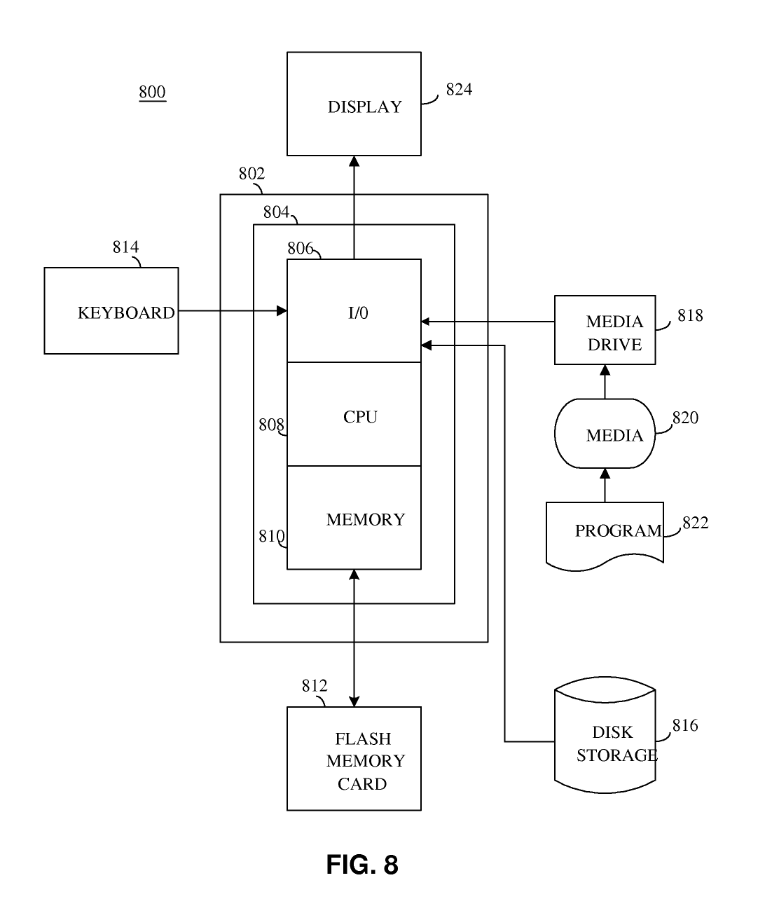

It should be noted that although the exemplary methods and systems described herein describe use of a separate server and database systems for performing various functions, other embodiments could be implemented by storing the software or programming that operates to cause the described functions on a single device or any combination of multiple devices as a matter of design choice so long as the functionality described is performed. Although not depicted in the figures, server 20, database system 28, and advertiser server network 40 generally include such art recognized components as are ordinarily found in server systems, including, but not limited to, processors, RAM, ROM, clocks, hardware drivers, associated storage, and the like (see, e.g., FIG. 8, discussed below). Further, the described functions and logic may be included in software, hardware, firmware, or combination thereof.

FIG. 2 depicts an exemplary advertising platform 100 for targeting advertisements received from multiple advertising networks, advertisers, publishers, end users of social network applications, and so on, to users of social network applications. For example, social advertisement platform 100 may be in communication with one or more advertisement networks 110 and 112. Each advertisement network 110 may communicate with publishers 120 and 122, which in turn receive advertisements from advertisers 130, 132, 134, and 136. Additionally, each advertiser network 110 may communicate with and receive advertisements directly from advertisers 140 and 142.

In one example, advertisement networks 110 and 112 may include back-end service providers for placing advertisements on websites or social networking sites. Publishers 120 and 122 may include social networking sites or other applications generally directed to users of social applications. Advertisers 130, 132, 134, 136, 140, and 142 may include various entities such as companies, individuals, social networking users, social networking user groups, and so on. In some instances, a single entity may include a combination of an advertising network, publisher, and/or advertiser.

With continued reference to FIG. 2, an illustrative example of requesting an advertisement will be described. Advertiser 140 may request to place an advertisement, the request including advertisement details, bid details, targeting criteria, and any additional content for display with the advertisement. The advertisement request is communicated to social advertiser platform 100 via advertisement network 110 (or directly thereto). Social advertisement platform 100 may then process the advertisement request, e.g., via a bidding process, and place the advertisement according to a social networking targeting algorithm as described below. In one example, social advertisement platform 100 may place the advertisement to publisher 120 or 122 via advertisement network 110 or 112 (or directly thereto) depending on the particular placement processes.

It should be understood that the exemplary relationships shown between the advertiser network, publishers, and advertisers shown in FIG. 2 are illustrative only, and that many other relationships, configurations, and communication paths are possible and contemplated. In some examples, publishers and advertisers may both place and publish advertisements, and may form their own advertising network. Further, an advertising network for use with an exemplary social networking application may comprise a single advertiser communicating directly or indirectly with a social networking server or backend. Further, exemplary processes described herein may be carried out solely within an advertiser network (e.g., 110 or 112), that is, without advertiser platform 100.

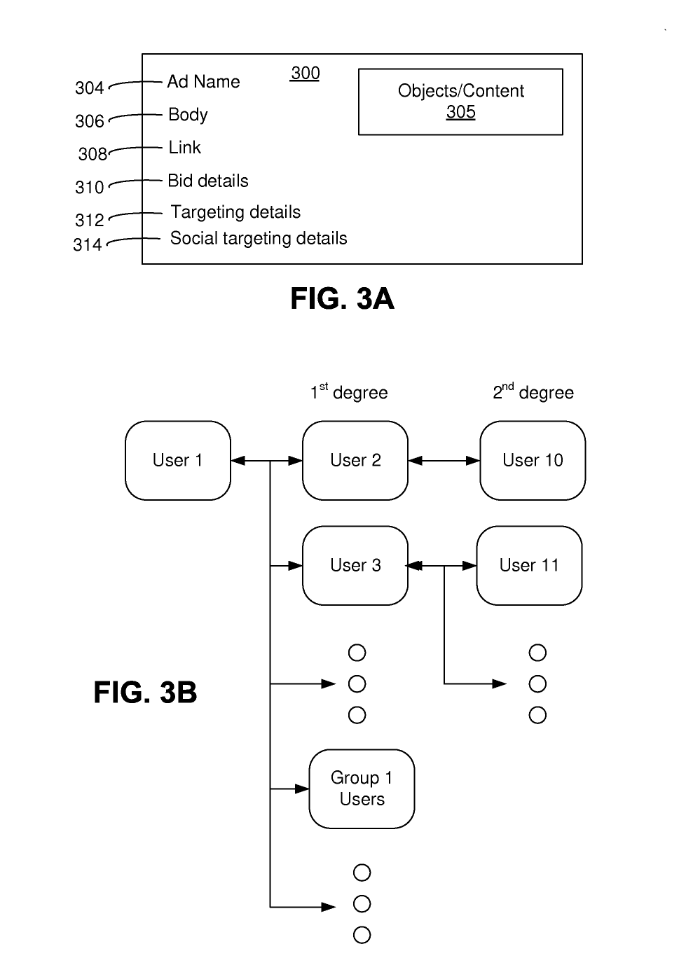

FIG. 3A illustrates an exemplary advertisement request 300. The advertisement request 300 may generally include an advertisement name 304, body 306, link 308, bid details 310, targeting details 312, and social targeting details 314. Generally, advertisement name 304 identifies the advertisement and may appear at the top of a displayed add followed by the advertisement body 306 (in other examples, advertisement name 304 is only used on the back-end to identify the advertisement request). The advertisement body 306 may include text as well as embedded objects 305, such as images, audio or video files, and so on. The advertisement request 300 may further include embedded links 308 to additional content, forms, surveys, or the like. Bid details 310 may include various pricing details and budget details; for example, including maximum bid price, selections of Cost Per Click (CPC) or Cost Per Impression (CPM) billing, time periods to run advertisement, daily or overall budgets, and so on.

Advertisement request 300 may further include targeting details 312, which may include attributes or criteria such as geographical or demographic information of targeted users. For example, selected targeting details 312 might include a selection for users who live in California, are female, and between 18 and 25 years old. Targeting details 312 may be used as filter criteria and/or for weighing or ranking advertisements for selection in a bidding process.

Advertisement request 300 may further include social targeting details 314, which may include or indicate social attributes associated with the requester's social networking information. For example, the social attributes may comprise a user's (or entity's) contacts or social groups (sometimes referred to as a “social graph”). In one example, the advertising request 300 may be used to target users having one degree of separation from the user submitting the advertisement request. In the case of a user, the advertisement can then target direct connections or friends of the user submitting the advertisement request. In the case of an entity, such as a corporation within a social networking application, e.g., a fan page or community page, or where an entity is registered similarly to a user, the advertisement can target users that are members or fans associated with the entity. FIG. 3B illustrates schematically first degree connections of user 1, shown as users 2 and 3. Additionally, user 1 is a member of group 1 and, in one example, the advertisement can be directed to users of, or associated, with group 1.

In another example, the advertisement may additionally or alternatively be targeted to a second degree of separation (e.g., connections of direct connections or friends of friends) as illustrated in FIG. 3B. The second degree connections are illustrated as users 10 and 11. As described herein, the advertisement generation algorithm may then use the advertisements, with their associated targeting details 312 and social targeting details 314, to place the advertisement within a social networking website page. It will be recognized that the process may extend to n-th degree connections.

The social attributes of the first user (e.g., connections or social groups) can be identified in advertisement request 300 or later by the advertisement network and/or social network when processing the request or placing the advertisement. For example, the social targeting details may indicate one or more of “first degree targeting,” “second degree targeting,” or “social group targeting.” Advertisement request 300 itself may identify second users that should be targeted or merely identify that the category of second users that should be targeted when the advertisement is placed. In either case, the identity of the second users may be identified or retrieved from the requester's profile information, from the social networking application, and so on.

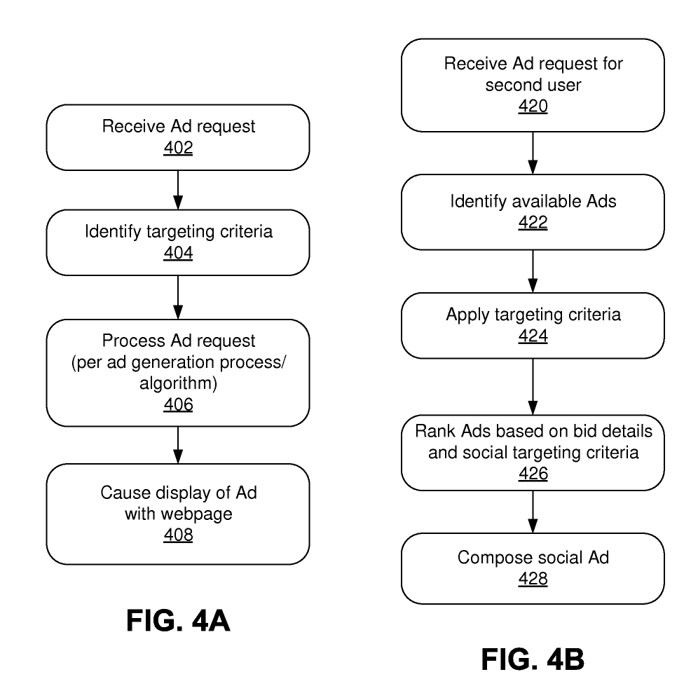

FIG. 4A illustrates an exemplary process for targeting advertisements within a social networking environment. An advertisement request is initially received at 402; for example, an advertisement request as illustrated in FIG. 3A. Targeting criteria is identified at 404, which may include geographic, temporal, demographic, or social targeting criteria for targeting the advertisement to users of the social network application. In one example, social targeting criteria may include the degree of contact (e.g., first or second degree of contacts/friends, social group(s)) between the requester and users of the social network. Further, the social targeting criteria can be used to target users across different social networks; for example, because the process is based upon the social graph built across different vertical advertisement networks under or associated with the social advertisement platform (see, e.g., social advertisement platform 100 of FIG. 2). For example, user A may know user B, and user B knows user C, wherein user A is only on Facebook™, user B is on both Facebook™ and Dogster™, and user C is only on Dogster™ (and not Facebook™). If user A places a 2nd degree advertisement within the social advertisement platform, without specifying a particular advertisement network or publisher, the advertisement can be placed with user C as well.

The advertisement request is processed according to a social advertising generation processes or algorithm at 406 to determine advertisements for display to users. For example, when a user requests or accesses a webpage of a social networking application having an advertising spot, the generation algorithm processes available advertisements with context of the user and the social targeting criteria to cause display of an advertisement at 408. For example, when placing an advertisement to a particular user, filtering criteria may be used to determine if the user is within the social targeting criteria (e.g., within a specified degree of contact, social group, etc. of the user who generated the advertisement) and processes the available advertisements according to a bid algorithm to place one or more advertisements. In other examples, the social targeting criteria may be used to weigh or score advertisements bidding for the advertisement spot within, for example, a variable price bidding algorithm.

In some examples, the generation algorithm may include an adaptive pattern matching algorithm, which adapts over time to outcomes of placing advertisements to users having particular attributes. For instance, examining advertisement data and user attributes, an adaptive algorithm may identify that certain user attributes, such as demographic information or social information, results in a higher or lower probability of a desired outcome (e.g., click, conversion, etc.) for particular advertisements. As the algorithm identifies or learns particular associations over time, the algorithm may adapt to direct or match particular advertisements to particular users for improved performance.

FIG. 4B illustrates an exemplary social advertisement generation process, which may be carried out within the process described in FIG. 4A. In one example, the advertisement generation process includes one or more bid-based, variable-based pricing algorithms carried out by an advertising server or network. In general, when a user displays a page including an advertisement spot, e.g., opens a page of a social networking application or the like, the algorithm carries out an auction for the advertisement spot and selects an advertisement for placement (in some cases there are multiple advertisement spots and one or more auctions may be carried out to place advertisements). In one example, all bids that target a particular user, e.g., the user's demographic, geographic, and social information, etc., are used to determine a winner or scoring/ranking of the potential advertisements. In situations where there are multiple advertisement spots, there can be multiple winners, where certain positions on the page may be influenced by the amount each has bid and/or relevancy of the advertisements to the user. For example, the advertisement with the highest bid generally shows up first or largest, though additional factors such as advertisement quality or relevance may be used.

In one example, an advertisement server receives a request for a social advertisement at 420; for example, for a second user different than the first user who submitted an advertisement request. The advertisement server may retrieve the available advertisements or identify a number of potential advertisements at 422. For example, the advertising server may retrieve or identify bid details, targeting details, and social targeting details of advertisements that may be placed. Targeting details and social targeting criteria may be applied to advertisements when retrieving at 424. In one example, the targeting details and social targeting criteria are used to filter out advertisements that do not satisfy the targeting details or social targeting criteria. In other examples, the targeting details, e.g., including geographical and demographic data, are used to filter out advertisements, and the social targeting criteria are used to weigh or score the retrieved advertisements. In yet other examples, both the targeting details and the social targeting criteria are used to weigh or score the retrieved advertisements in an advertisement generation process.

The advertisement server may then rank or score the advertisements at 426 based on bidding details and social targeting criteria at 426. For example, the advertisement server may determine or compute which advertisement(s) have the greatest expected value based on bid prices and social targeting criteria. The ranking or scoring process may further be used to weigh each of the identified advertisements based on bid details and social targeting criteria for placement; for example, assuming common social targeting criteria, a higher bid price advertisement will be placed more frequently and/or prominently than a lower bid price advertisement.

In one example, an advertisement selection probability model is used to select the advertisement after the selection criteria and social targeting criteria have been applied. Such a process may first determine a weight for each potential advertisement. One exemplary manner to determine a weight is as follows (however, it should be recognized that various other equations and processes for calculating advertisement weights may be used):

Advertisement weight(w)=EXP(P*(Effective Bid Price)/(Max. Bid for Category))

In this example, P is a parameterized value (e.g., “5”) that can be varied or removed to alter the impact of the effective bid price, where the effective bid price can equal the actual bid price or the actual bid price subject to a variable price adjustment process (up or down). For example, a variable price adjustment can be used to adjust an actual advertisement bid price based on a multitude of factors, including, but not limited to, campaign spending of the advertiser, cost per acquisition/transaction, clicks or impressions per advertisement billing, affiliate campaigns, conversion ratios, and so on. Additionally, the actual bid price may be varied based on targeting details such as user attributes or demographic data (additionally, a multi-phase regression analysis may performed to identify influential variables for targeting advertisements), social targeting criteria (such as the first to n-th degree social connections, social groups, etc.), social behavior/interaction data (e.g., interaction or feedback patterns collected from social data and advertisement interactions as described below), or the like.

As an illustrative example of selecting a weighted advertisement, suppose there are three advertisements having the following calculated weights, and thus probabilities of being placed:

| | | Probability of selection |
|---|---|---|
| Advertisement | Weight (w) | (=w/sum of all w *100) |
| Ad1 | 4 | 4/11*100 = 36 |
| Ad2 | 5 | 5/11*100 = 45 |
| Ad3 | 2 | 2/11*100 = 18 |

When the process selects an advertisement for placement, an advertisement may be selected based on these placement probabilities, e.g., placing Ad2 45% of the time, Ad1 36% of the time, and Ad3 18% of the time. The process may utilize a random number generator or the like to select one of the advertisements according to the probabilities.

Further, in one example, filters based on parameters collected from the advertiser can be built into a profiling feature vector, the profiling feature vector including targeting details of the advertisement such as demographic data, or any statistically significant publisher specific variables that may be used for targeting users. In one example, a pattern matching algorithm may be used to identify influential variables for targeting. The pattern matching algorithm may include a multi-phase regression analysis, genetic algorithm, neural network algorithm such as a resilient back-propagation (RPROP) neural network, or other learning algorithm or heuristic model for providing an adaptive mechanism based on past outcomes to improve the output of the algorithm over time. For example, an advertising generation process may attempt to match the advertiser's targeting details to the user's profile information to the extent possible; for example, matching an advertisement directed to males between 18-25 years old. In some instances, however, targeted users may nevertheless have a very low selection rate (i.e., poor outcome) for the particular advertisement. Accordingly, the process may change or expand the targeting details, for example to males between 25-35 years old, in an attempt to “learn” user attributes that will increase or optimize selections of the advertisements based upon historical interactions (in other examples, a small percentage of placements may be intentionally outside of the targeting criteria to gather outcome data on user's outside of the targeting criteria). The algorithm may determine coefficients of the targeting details for each advertisement and match more relevant users to the particular advertisement. Additionally, the discovery of modified or improved targeting details may feedback to the advertisers for advertisement optimization.

In another example, the process may include a filter based on the social targeting criteria. For instance, a first, second, and/or n-th degree social graph may be determined and used in the advertisement placement process. Generally it is the case that not all first degree social connections are as strong or relevant in determining common interests, likes, etc. Accordingly, in one example, the particular set of connections may be optimized by determining common social aspects shared between certain users. For example, the number of common connections or social groups between two users (e.g., many common connections generally indicating two users are closer connections than if no common connections), connection status across multiple social networks (e.g., where two users are connected within two different social networking applications such as Facebook™ and LinkedIn™), social activities, exchanged emails/chats, and so on, can be used to prioritize or weigh connections of particular users. Strongly linked users may be more likely to have similar response to advertisements (e.g., like and dislike similar items, services, content, etc.).

The advertisement server may compose the advertisement for placement within the webpage at 428 based upon the ranking or scoring of identified potential advertisements. If more than one advertisement is requested for a particular webpage, the advertisement server may select the appropriate number of advertisements as ranked or scored in 426; in other examples, the process may be performed for each placement.

It should be understood that the processes illustrated in FIGS. 4A and 4B are illustrative only and that certain acts may be omitted and additional acts may occur. For example, exemplary processes may include various user login and authentication processes, user identification processes when accessing a webpage, and so on. Further, certain acts need not occur in the order in which they are shown and described, and some acts may occur at least partially in parallel. For example, a bidding process may occur before or after filtering criteria are applied to potential advertisements, and in some examples, may occur simultaneously or as part of a single process.

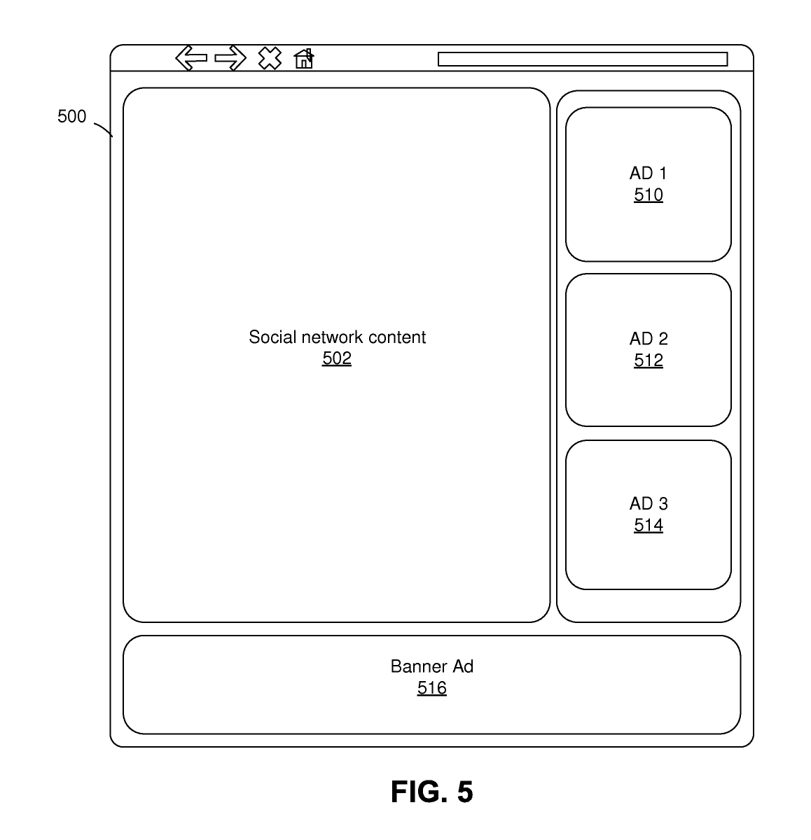

FIG. 5 illustrates an exemplary screenshot illustrating the display of advertisements within a social network webpage 500. In this example, webpage 500 includes display space 502 for social networking content, display space 502 positioned prominently with webpage 500, and further includes advertisements spots 510, 512, 514, and 516 displayed to the side and bottom of webpage 500. In some examples, it may be determined that advertisement spot 510 is the most likely position for obtaining attention (e.g., a click) of a user, with advertisements spots 512, 514, and 516 having less likelihood of obtaining the attention of a user. Accordingly, the “winner” of the social advertisement generation process, e.g., of an auction/bid process including social targeting criteria, may be placed in advertisement spot 510. In other examples, various configurations of content and advertisements are contemplated, including banner adds at the top, left, pop-up advertisements, advertisements embedded or interleaved with the content, and so on. Accordingly, the “winner” position within a webpage having multiple advertisement spots may vary depending on the particular configuration, and further may change over time based on user preferences for viewing advertisements.

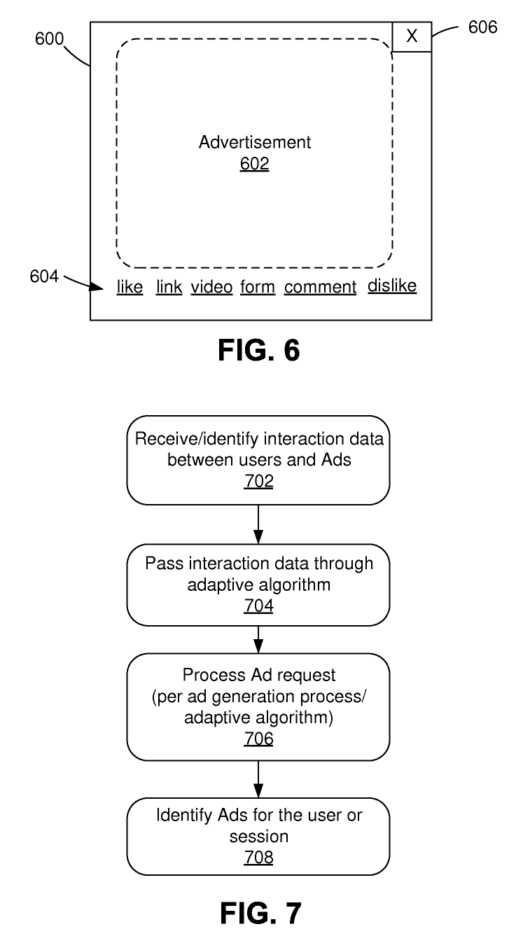

FIG. 6 illustrates an exemplary advertisement 600 for placement in advertisement spot 510 of FIG. 5. Generally, advertisement 600 includes advertisement content 602, which generally includes information according to the advertisement request, such as body text, images, media objects such as audio or video files, links to additional information, and so on. Advertisement 600 may further include a variety of feedback features. For example, including a hide or close selection 606, which closes or removes the advertisement when selected. In some examples, when selection 606 is made the user may be asked the reason for closing advertisement 602, e.g., “not interested,” “already own,” “irrelevant,” and so on. Additionally, advertisement 600 may include various selections or links indicated at 604. Links 604 may provide feedback (e.g., like or dislike), provide a link to other webpages or websites (e.g., the advertiser's website), provide a link to additional content (e.g., video and or audio objects), forms or surveys associated with the advertisement, comments, and so on.

Any action taken by a user, e.g., selection of advertisement 602, links 604, or close selection 606, or the like, may be stored by the social networking application and the advertising network for subsequent placement of advertisements. For example, the information may be used across the advertising network as well as for targeting advertisements to the particular user providing the input. In particular, the outcome data may be used as feedback to train an adaptive pattern matching algorithm as described, thereby potentially improving the advertisement generation and placement process.

In some examples, the feedback for a particular user can be used to influence advertisements targeted to the user's social contacts, e.g., first and second degree connections, social groups, and so on. The advertisement generation algorithm may make certain inferences regarding users based on feedback to advertisements by the user and/or the user's connections. For instance, if user A likes fantasy football (e.g., based on profile information or responding positively to advertisements associated therewith), the system may make an inference that user A's first degree connections are likely to also like fantasy football, and target advertisements accordingly. If a first degree or direct connection, e.g., user B, subsequently indicates that they do not like fantasy football that connection between users A and B can be broken or diminished. As users interact with the advertisements over time, thereby providing greater feedback, the advertising algorithm can provide more targeted advertisement placement. As such, the strengths of connections between various users can be determined and used to weigh potential advertisements for users.

In one example, the process may build profile correlation dependence mapping and ontology structures based upon interaction patterns collected from the social graphs (e.g., first, second, n-th degree connections). In particular, the interactions between the advertisement and the user may be used for training an adaptive or pattern matching algorithm, such as an artificial intelligence algorithm, neural network algorithm, or the like, which in turn identifies the most relevant users in the social graph. Additionally, keyword based targeting of advertisements allows a system to generate an ever-growing ontology structure for feature vector exploration. For example, by running a pattern matching algorithm, such as a genetic algorithm, on a feature vector associated with targeting details of an advertisement, the system may discover the users within the optimized social graph that may exhibit similar but untapped behavioral pattern(s) (e.g., identify users or user groups that may interact with an advertisement favorably or unfavorably).

FIG. 7 illustrates an exemplary social advertisement generation process based on an interaction pattern and adaptive algorithm. The process includes receiving or identifying interaction data at 702. For example, interaction data may include data associated with a user clicking on an advertisement, selecting “like,” “dislike,” and so on. The interaction data may further include or be associated with user data, which may include demographic data as well as various social graph data as described (e.g., connections, social groups, etc.), and advertisement data, which may include demographic and social targeting criteria.

The interaction data, including user data and advertisement data, may be passed through an adaptive algorithm at 704. In particular, the adaptive algorithm can be trained on the interaction data; for example, where the interaction data is outcome data and the user data and advertisement data is the matching input data. The adaptive algorithm may include a pattern matching algorithm such as an AI algorithm, regression analysis algorithm, neural network algorithm, etc., which can be tuned or modified based on the interaction data. Additionally, an ontology structure may be built based on the interaction data, which in turn can be used to build a profile correlation dependence mapping and ontology structures.

An advertisement may then be processed according to the adaptive algorithm at 706. In one example, a feature vector (i.e., the targeting details of the advertisement) may be processed by the adaptive algorithm to identify user demographic or social attributes that are likely to interact with the advertisement in a desired manner. That is, by training or tuning the adaptive algorithm on previous interaction data in 704, the algorithm can discover or identify users at 708 that may exhibit similar behavioral and interaction patterns and place advertisements accordingly (or at least use the information in a bidding process as described, e.g., to weigh or adjust a bid price up or down).

FIG. 8 depicts an exemplary computing system 800 configured to perform any one of the above-described processes. In this context, computing system 800 may include, for example, a processor, memory, storage, and input/output devices (e.g., monitor, keyboard, disk drive, Internet connection, etc.). However, computing system 800 may include circuitry or other specialized hardware for carrying out some or all aspects of the processes. In some operational settings, computing system 800 may be configured as a system that includes one or more units, each of which is configured to carry out some aspects of the processes either in software, hardware, or some combination thereof.

FIG. 8 depicts computing system 800 with a number of components that may be used to perform the above-described processes. The main system 802 includes a motherboard 804 having an input/output (“I/O”) section 806, one or more central processing units (“CPU”) 808, and a memory section 810, which may have a flash memory card 812 related to it. The I/O section 806 is connected to a display 824, a keyboard 814, a disk storage unit 816, and a media drive unit 818. The media drive unit 818 can read/write a computer-readable medium 820, which can contain programs 822 and/or data.

At least some values based on the results of the above-described processes can be saved for subsequent use. Additionally, a computer-readable medium can be used to store (e.g., tangibly embody) one or more computer programs for performing any one of the above-described processes by means of a computer. The computer program may be written, for example, in a general-purpose programming language (e.g., Pascal, C, C++) or some specialized application-specific language.

Although only certain exemplary embodiments have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

We claim:

1. A computer-implemented method for selecting advertisements for display to users of a social networking application, the method comprising the acts of:
receiving interaction data associated with interactions between users and advertisements;
training an adaptive algorithm based on the interaction data, user data, and advertisement data; and
selecting an advertisement for display to a user based on the trained adaptive algorithm.

2. The method of claim 1, further comprising identifying second users of a first user's social graph that are likely to exhibit similar interactions with advertisements.

3. The method of claim 1, wherein the adaptive algorithm prioritizes second users of a first user's social graph based on common interaction data.

4. The method of claim 1, wherein selecting an advertisement for display is further based upon a bid-based, variable pricing algorithm.

5. The method of claim 1, wherein selecting the advertisement for display to a user comprises selecting at least one second user from a first user's social graph based on the adaptive algorithm.

6. The method of claim 1, further comprising building an ontology structure based on the interaction data.

7. The method of claim 1, further comprising using an ontology structure to expand the advertisement data for use in the adaptive algorithm.

8. The method of claim 1, further comprising identifying potential user attributes to target based on the trained adaptive algorithm and a received advertisement request.

9. The method of claim 1, wherein training the adaptive algorithm comprises passing the interaction data through the adaptive algorithm and adjusting one or more coefficients thereof.

10. The method of claim 1, wherein the adaptive algorithm comprises any one or more algorithms selected from the group consisting of an adaptive pattern matching algorithm, regression analysis algorithm, neural network algorithm, or genetic algorithm.

11. A computer-readable storage medium for selecting advertisements for display to users of a social networking application, the computer-readable storage medium comprising instructions for:
receiving interaction data associated with interactions between users and advertisements;
training an adaptive algorithm based on the interaction data, user data, and advertisement data; and
selecting an advertisement for display to a user based on the trained adaptive algorithm.

12. The computer-readable storage medium of claim 11, further comprising instructions for identifying second users of a first user's social graph that are likely to exhibit similar interactions with advertisements.

13. The computer-readable storage medium of claim 11, wherein the adaptive algorithm prioritizes second users of a first user's social graph based on common interaction data.

14. The computer-readable storage medium of claim 11, wherein selecting an advertisement for display is further based upon a bid-based, variable pricing algorithm.

15. The computer-readable storage medium of claim 11, wherein selecting the advertisement for display to a user comprises selecting at least one second user from a first user's social graph based on the adaptive algorithm.

16. The computer-readable storage medium of claim 11, further comprising instructions for building an ontology structure based on the interaction data.

17. The computer-readable storage medium of claim 11, further comprising instructions for using an ontology structure to expand the advertisement data for use in the adaptive algorithm.

18. The computer-readable storage medium of claim 11, further comprising instructions for identifying potential user attributes to target based on the trained adaptive algorithm and a received advertisement request.

19. The computer-readable storage medium of claim 11, wherein training the adaptive algorithm comprises passing the interaction data through the adaptive algorithm and adjusting one or more coefficients thereof.

20. The computer-readable storage medium of claim 11, wherein the adaptive algorithm comprises any one or more algorithms selected from the group consisting of an adaptive pattern matching algorithm, regression analysis algorithm, neural network algorithm, or genetic algorithm.

21. A system comprising a processor and the computer-readable storage medium of claim 11.
